(19) United States
(12) Patent Application Publication
(10) Pub. No.: US 2020/0175518 A1
(43) Pub. Date: Jun. 4, 2020

(54) APPARATUS AND METHOD FOR REAL-TIME DETECTION OF FRAUDULENT DIGITAL TRANSACTIONS

(71) Applicant: JEWEL PAYMENTECH PTE LTD, Singapore (SG)

(72) Inventors: Benjamin Min Xian CHU, Singapore (SG); Jer-Wei LAM, Singapore (SG); Jeanette Yi Wen TAN, Singapore (SG); Azim Adil YAZDANI, Singapore (SG)

(73) Assignee: Jewel Paymentech Pte Ltd, Singapore (SG)

(21) Appl. No.: 16/491,840

(22) PCT Filed: Mar. 8, 2017
(86) PCT No.: PCT/SG2017/050108

§ 371 Date: Sep. 6, 2019

(51) Int. Cl. G06Q 20/40; G06N 20/00

(52) U.S. Cl. CPC G06Q 20/4016; G06N 20/00; G06Q 20/405

(57) ABSTRACT

An apparatus (100) for real-time detection of fraudulent digital transactions is disclosed. The apparatus comprises: a transceiver module arranged to receive information data of a digital transaction; a model generator module (102) arranged to dynamically generate a predictive model for fraud detection based collectively on historical information data relating to identified fraudulent transactions and the received information data; and a fraud detection module (104) having a plurality of anomaly detection modules (1042, 1044, 1046) arranged to respectively process the received information data differently to generate a plurality of scores, which are aggregated to provide an aggregated score to enable real-time determination of whether the digital transaction is a fraudulent digital transaction. A first anomaly detection module (1042) is configured to process the received information data using the predictive model to generate a first score. A related method is disclosed too.

### FIELD

The present invention relates to an apparatus and method for real-time detection of fraudulent digital transactions.

### BACKGROUND

In modern times, fraud has become a billion-dollar generating business for fraud perpetrators, and continues to increase annually, to the detriment of the honest population. Fraudsters find various innovative means and ways to commit fraud, partially thanks to rapid development/adoption of new technologies for digital transactions. Apart from that, business re-organization and re-engineering may also slow down or eliminate control, while utilisation of new information systems may then present further and new opportunities to commit fraud.

Previously, data analytics tend to be deployed to identify fraud, but data analytics require time-consuming investigations that are normally associated with various domains of knowledge for instance economics, financial, business practices, financial and/or law. But there is still a main problem when faced with the following situation: there are potential ethical issues when genuine credit card customers are misclassified as fraudsters, which is undesirable.

Take for an example, in the following sentence: “Fraud occurs when a merchant is tricked by a purchaser offering his/her purchases, believing that the purchaser's credit card account will provide payment for this purchase. Ideally, no payment will be made. If the payment is made, the credit card issuer will reclaim the amount paid. Currently, most credit card fraud is conducted via e-commerce purchases (Card Not Present transactions). Fraudsters may also have connections with merchants, in the event of syndicated fraud. In the credit card business, fraud can be committed by an internal party but often also by an external party. As an external party, fraud is committed being a prospective/existing purchaser or a prospective/existing merchant.”

For companies dealing with hundreds/thousands of external parties in transactional activities, it is highly cost prohibitive and laborious to manually check on the identities and transactional activities of a large majority of those external parties. Notably, direct overhead costs will be incurred for each suspicious transaction, if the companies choose to investigate them. Moreover, if the amount of a transaction made is less than the overhead costs to be incurred for the investigation, the investigation may not be worthwhile conducting, even if the transaction seems suspicious prima facie.

A solution to the above is to use machine learning (ML) algorithms, which are programmed to take into consideration many relevant factors to qualify a transaction as potentially fraudulent. Particularly, the ML algorithms are configured to learn, over time, between what is legitimate/shady, pertaining to digital transactions. Generally, ML algorithms refer to self-improving algorithms, which are predefined processes (executed by a computing device) in conformance to specific rules set out, where an initial model is first used by the ML algorithm and then the model is gradually improved by training using relevant datasets through trial and error. ML algorithms for fraud detection need to be trained first via feeding transaction data (as training data) to the ML algorithms. Transaction sequences are an example of the training data. For example, an individual may typically pump gas once a week, or go for fine dining every two weeks and so on. The ML algorithm consequently learns that this is a normal transaction sequence for that individual concerned.

One object of the present invention is therefore to address at least one of the problems of the prior art and/or to provide a choice that is useful in the art.

### SUMMARY

According to a 1^{st} aspect, there is provided an apparatus for real-time detection of fraudulent digital transactions, comprising: a transceiver module arranged to receive information data of a digital transaction; a model generator module arranged to dynamically generate a predictive model for fraud detection based collectively on historical information data relating to identified fraudulent transactions and the received information data; and a fraud detection module having a plurality of anomaly detection modules arranged to respectively process the received information data differently to generate a plurality of scores, which are aggregated to provide an aggregated score to enable real-time determination of whether the digital transaction is a fraudulent digital transaction. A first anomaly detection module is configured to process the received information data using the predictive model to generate a first score.

Preferably, the fraud detection module may further include an aggregation module configured to aggregate the first and second scores to provide the aggregated score.

Preferably, the transceiver module may include being configured to transmit the aggregated score to a payment server from which the digital transaction originates.

Preferably, the first and second scores may be arranged to be normalised, prior to being aggregated.

Preferably, the model generator module may include being configured to use machine learning to dynamically generate the predictive model.

Preferably, the model generator module may include: a data transformation module to process the received information data into an associated data representation with reference to a predetermined format; an extraction module to extract respective values of predetermined data fields in the data representation; and a model building module to generate the predictive model based on the extracted values.

Preferably, the fraud detection module may be further configured to provide an anomaly score, and the apparatus may further comprise: a recommender module arranged to receive the anomaly score and compare the anomaly score with a threshold value to generate a signal. Based on the generated signal, the recommender module is configured to trigger at least one rule from a fraud rules database, and a weightage value associated with the triggered rule is provided to at least the first anomaly detection module to enable the first anomaly detection module to use the weightage value to process information data of a new digital transaction received

Preferably, the at least one rule may also include a plurality of rules, and respective weightage values are associated with respective rules, and; the weightage values are combined and normalized into a single weightage value which is provided to the first anomaly detection module.

Preferably, a second anomaly detection module may be configured to process the received information data using semantic anomaly detection or velocity detection with temporal analysis to generate a second score.

Preferably, the aggregated score may be compared against a predetermined threshold value, in which the aggregated score being greater than the threshold value indicates a fraudulent digital transaction, and the aggregated score being smaller than the threshold value indicates a non-fraudulent digital transaction.

Preferably, the apparatus may include a computing device.

According to a 2^{nd} aspect, there is provided a method performed by an apparatus for real-time detection of fraudulent digital transactions, the apparatus includes a transceiver module, a model generator module, and a fraud detection module having a plurality of anomaly detection modules. The method comprises: (i) receiving information data of a digital transaction by the transceiver module; (ii) dynamically generating a predictive model for fraud detection by the model generator module based collectively on historical information data relating to identified fraudulent transactions and the received information data; and (iii) respectively processing the received information data differently by the plurality of anomaly detection modules to generate a plurality of scores, which are aggregated to provide an aggregated score to enable real-time determination of whether the digital transaction is a fraudulent digital transaction, wherein the received information data is processed by a first anomaly detection module using the predictive model to generate a first score.

It should be apparent that features relating to one aspect of the invention may also be applicable to the other aspects of the invention.

These and other aspects of the invention will be apparent from and elucidated with reference to the embodiments described hereinafter.

### BRIEF DESCRIPTION OF THE DRAWINGS

Embodiments of the invention are disclosed hereinafter with reference to the accompanying drawings, in which:

FIG. 1 shows the schematic architecture of an apparatus for real-time detection of fraudulent digital transactions, according to an embodiment;

FIG. 2 is flow diagram of a corresponding method performed by the apparatus of FIG. 1 for real-time detection of fraudulent digital transactions;

FIG. 3 is a flow diagram of steps performed by a fraud detection module of the apparatus of FIG. 1;

FIGS. 4a to 4d in sequence collectively show flow diagrams of a method performed by a predictive anomaly detection module arranged in the fraud detection module; and

FIG. 5 is a flow diagram of steps performed by a semantic anomaly detection module arranged in the fraud detection module.

### DETAILED DESCRIPTION OF PREFERRED EMBODIMENTS

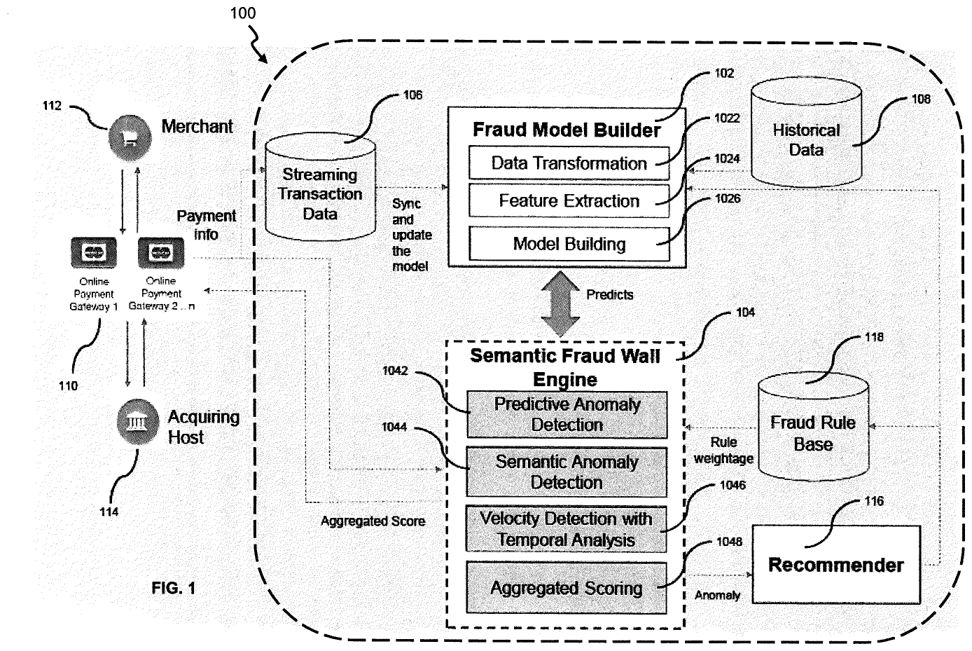

An apparatus 100 for real-time detection of fraudulent digital transactions is disclosed in FIG. 1, according to an embodiment. Particularly, the apparatus 100 (e.g. a computing device such as a server) is configured to use a semantic-based approach for the fraud detection. Broadly, the apparatus 100 comprises a transceiver module (not shown) arranged to receive information data of a digital transaction, a model generator module 102 (i.e. also known as a fraud model builder) arranged to dynamically generate a predictive model for fraud detection based collectively on historical information data relating to identified fraudulent transactions and the received information data, and a fraud detection module 104 (i.e. also known as a semantic fraud wall engine) having a plurality of anomaly detection modules 1042, 1044, 1046 arranged to respectively process the received information data differently to generate a plurality of scores, which are aggregated to provide an aggregated score to enable real-time determination of whether the digital transaction is a fraudulent digital transaction. A first anomaly detection module 1042 is configured to process the received information data using the predictive model (provided by the model generator module 102) to generate a first score, and may be termed (hereafter) as a predictive (or rule-based) anomaly detection module 1042. In one example, the aggregated score may be compared against a predetermined threshold value (e.g. selected by a user) by the apparatus 100, in which the aggregated score being greater than the threshold value indicates a fraudulent digital transaction, whereas the aggregated score being smaller than the threshold value indicates a non-fraudulent digital transaction.

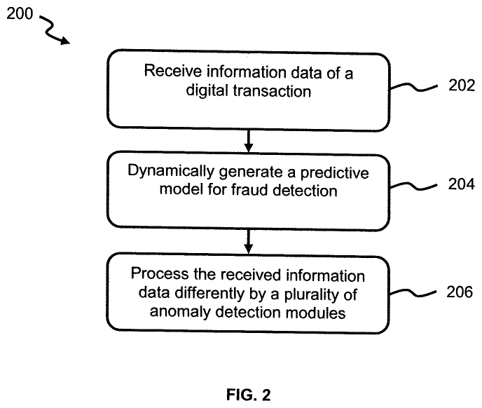

Correspondingly, a method 200 performed by the apparatus 100 for real-time detection of fraudulent digital transactions is depicted in FIG. 2. Specifically, the method 200 comprises: at step 202, receiving information data of a digital transaction by the transceiver module; at step 204, dynamically generating a predictive model for fraud detection by the model generator module 102 based collectively on historical information data relating to identified fraudulent transactions and the received information data; and at step 206, respectively processing the received information data differently by the plurality of anomaly detection modules 1042, 1044, 1046 to generate a plurality of scores, which are aggregated to provide an aggregated score to enable real-time determination of whether the digital transaction is a fraudulent digital transaction.

Referring back to FIG. 1, the received information data are stored in a streaming transaction database 106, and the historical data are stored in a historical database 108, in which both databases 106, 108 are provided as data inputs to the model generator module 102 to dynamically generate the predictive model. As information data of new digital transactions are received by the apparatus 100, the streaming transaction database 106 will continually be updated with those information data as they come in. That is, the apparatus 100 is configured to be able to process streaming transaction data as they are received, and provide real-time determination of whether any of those digital transactions are (potentially) fraudulent in nature. It is also to be noted that the predictive model is only generated once from the historical data, but as the streaming transaction data are received, those streaming transaction data are then used to continually update/enrich the initial predictive model. In one example, the predictive model continues to dynamically synchronize itself to learn and adjust, in view of the continually updated streaming transaction database 106. In this case, the streaming transaction database 106, and historical database 108 are configured as part of the apparatus 100, but it need not be so in variant embodiments. It is also to be appreciated that the digital transaction originates from an online payment server 110, when a payer (e.g. a customer) conducts an online transaction with a payee 112 (e.g. a merchant) for acquiring goods/services from the payee. To complete the digital transaction, the online payment server 110 also digitally communicates with an acquiring host 114 (e.g. a bank) to verify financial details (e.g. credit card information or the like) provided by the payer to complete the digital transaction. Accordingly, the transceiver module also transmits the aggregated score (output by the fraud detection module 104) to the online payment server 110, which consequently enables the online payment server 110 to determine whether the digital transaction is permitted to go through, on the basis of whether the digital transaction is a fraudulent digital transaction.

Then, the model generator module 102 includes a data transformation module 1022 to process the received information data into an associated data representation (i.e. data transformation) with reference to a predetermined format; an extraction module 1024 to extract respective values of predetermined data fields (i.e. selected salient features) in the data representation (i.e. feature extraction); and a model building module 1026 to generate the predictive model based on the extracted values (i.e. model building). It is to be appreciated that the selected salient features are essential features that a user (of the apparatus 100) wants the apparatus 100 to learn from the received information data and analyse what are the associated likelihoods of a fraudulent transaction. Also, selected salient features differ between different customers (i.e. as users of the apparatus 100, such as merchants, banks, financial institutions/organisations and etc.) in considering different parameter fields that need to be taken into account.

Moreover, the apparatus 100 may also (optionally) further includes a recommender module 116 arranged to receive an anomaly score (generated also by the fraud detection module 104) and compare the anomaly score with a threshold value to generate a signal. Consequently, based on the generated signal, the recommender module 116 is configured to trigger at least one rule from a fraud rules repository 118, and a weightage value associated with the triggered rule is then provided to at least the predictive anomaly detection module 1042 to enable the predictive anomaly detection module 1042 to use the weightage value to process information data of new digital transactions received subsequently. It is to be appreciated that the definition of at least one rule may also include a plurality of rules, and there are respective weightage values associated with the respective rules. In such an instance, the weightage values are combined into a single weightage value, which is then normalized thereafter and provided to the predictive anomaly detection module 1042. The rule(s) triggered can be a simple rule, a complex rule, or a mixture of simple and complex rules, depending on circumstances. In effect, the recommender module 116 functions as a reactor to the anomaly score by reacting to trigger a simple rule, or a complex rule from the fraud rules repository 118. To be clear, a simple rule entails a rule that looks into the transaction details of that one specific transaction alone, whereas a complex rule entails looking at transaction details of the specific transaction along with other historical transactions that have been previously analysed. Furthermore, rules defined in the fraud rules repository 118 are fully customizable, and can be propagated across multiple channels. In context of the preceding sentence, the definition of channels includes electronic commerce, Mail Order Telephone Order (MOTO), Virtual Terminals (vterms) and Point of Sale (POS). Also, the recommender module 116 transmits the signal to the model generator module 102, so that the model generator module 102 is updated and consequently configured to build an improved fitting predictive model to narrow down false positives in the next round of prediction. Then, the recommender module 116 also transmits a set of parameter of field values as well as a classification label to the model generator module 102, in order to enable the model generator module 102 to build a better predictive model for subsequent rounds.

To reiterate, each rule is associated with its own corresponding weightage value specified by a user. There are certain selected rules that are more important, which the user wants to imply that when these rules are triggered, it means that a digital transaction (being currently processed by the apparatus 100) is considered highly anomalous/suspicious. Therefore, those rules are associated with higher weightage values than the other rules. Moreover, the weightage value is not bounded by the complexity of the associated rule. Both simple and complex rules are defined such a way to facilitate the rule-based anomaly detection to go in conjunction with the predictive model.

Regarding the fraud detection module 104, a second, a third and a fourth of the anomaly detection modules 1044, 1046, 1048 may be (hereafter) termed respectively as a semantic anomaly detection module 1044, a velocity detection module 1046, and an aggregated scoring module 1048 (i.e. abbreviated to aggregation module). The aggregation module 1048 is configured to aggregate the plurality of scores to provide the aggregated score. It is however to be appreciated that in variant embodiments, only a minimum of two anomaly detection modules are necessary, one of which is to be the predictive anomaly detection module 1042. Also, the predictive anomaly detection module 1042 uses the fraud rules repository 118 to assist with fraud detection, as afore explained. More details on the respective anomaly detection modules 1042, 1044, 1046, 1048 are set out below.

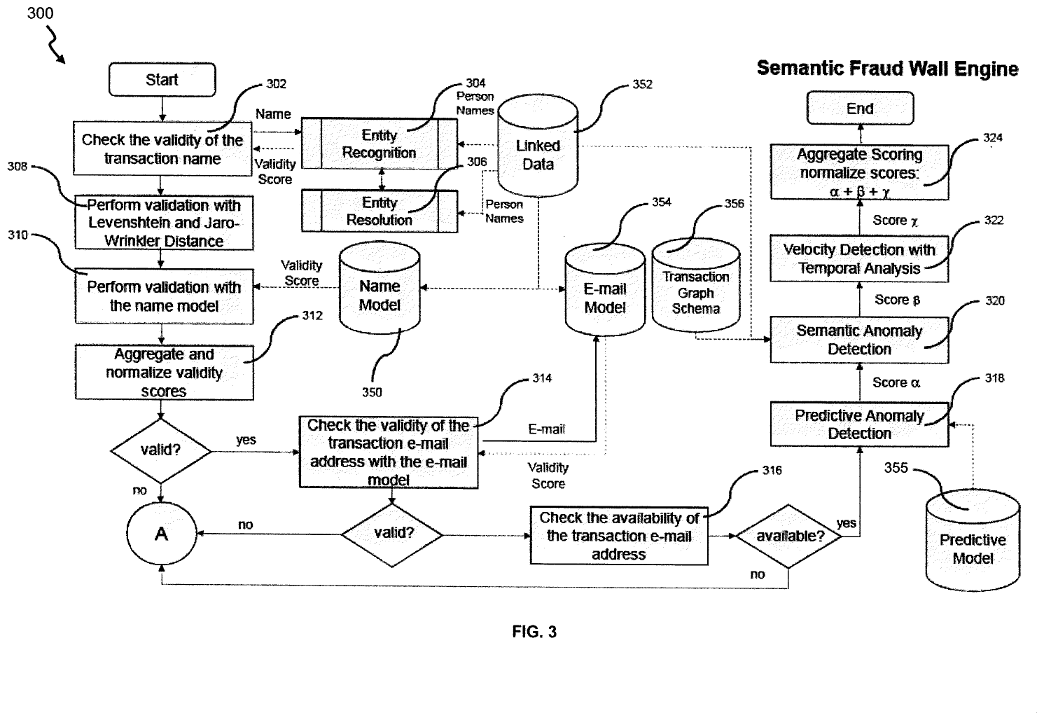

FIG. 3 is a flow diagram 300 of steps performed by the fraud detection module 104 for processing the received information data of the digital transaction. At step 302, a first validation of a transaction name (furnished by the payer for the digital transaction) is performed. In most instances, the payer's name is used for the transaction name. More specifically, the first validation is performed using an entity recognition technique at step 304 and depending on the result, a first validity score is returned. It is to be appreciated that gibberish, non-meaningful names and/or repetitive sequence(s) of characters in the transaction name are eliminated using the entity recognition technique with Linked data repositories 352 (which comprise many open repositories, e.g. DBPedia, Freebase, and etc.) is utilised by the fraud detection module 104 to build a Name Model 350.

Next, a second validation is performed (for name checking), whereby transactional records are merged and clustered by similar names. For example, the names “J Smith” and “John Smith” may appear to refer to a same person, therefore using an entity resolution with acronym and abbreviation finder technique at step 306 will be useful to resolve several names that may be referring to a same person. It is to be appreciated that the second validation is part of the first validation. Moreover, the string similarity distance Measure with Levenshtein and Jaro-Wrinkler techniques are performed at step 308 (which follows directly from step 302) to compare two different strings of names, and return a score (between 0-1). If the returned score is more than a similarity threshold defined by a user, then the name is resolved to the string with the longest length. All transactional records are then clustered by this resolved name. A third validation is performed at step 310 using the Name Model 350, and depending on the result, a second validity score is returned.

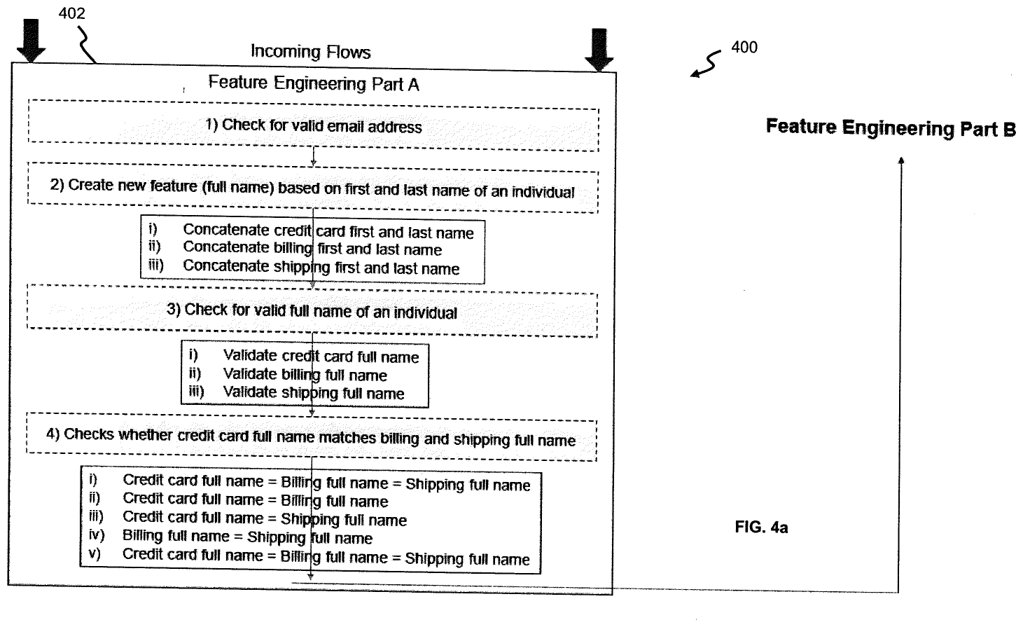

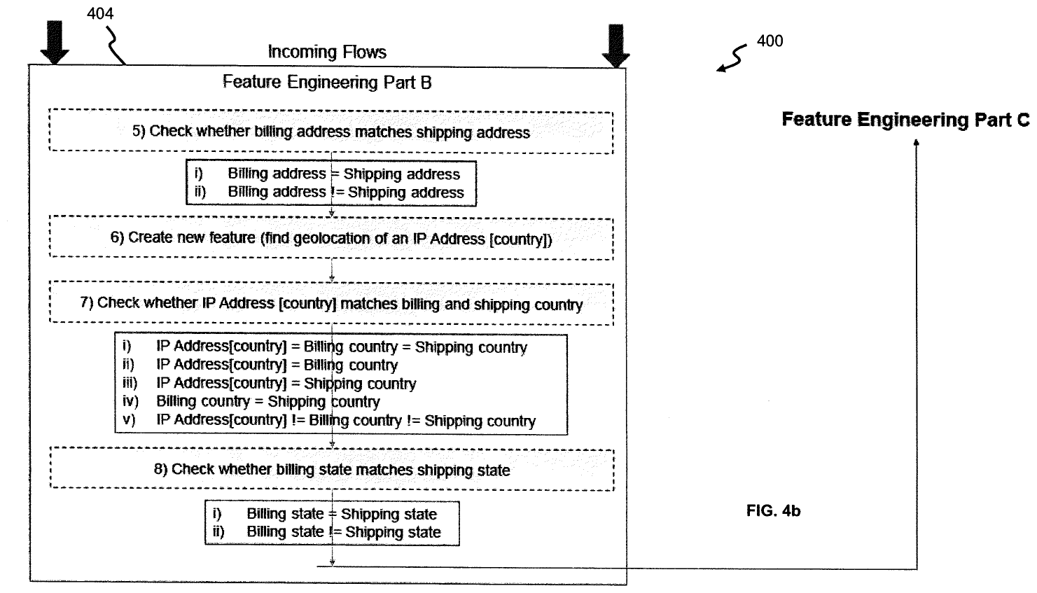

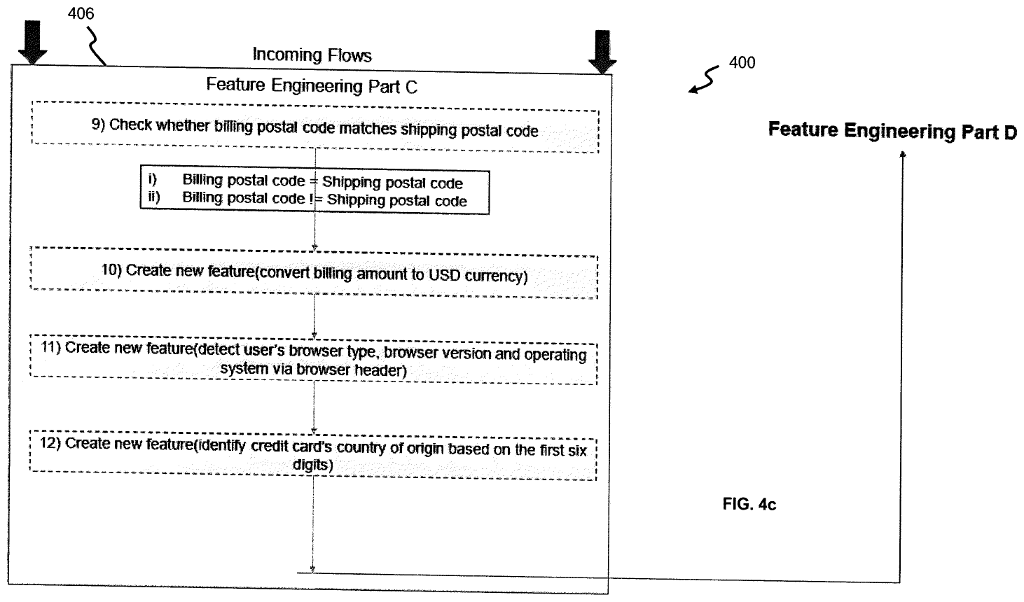

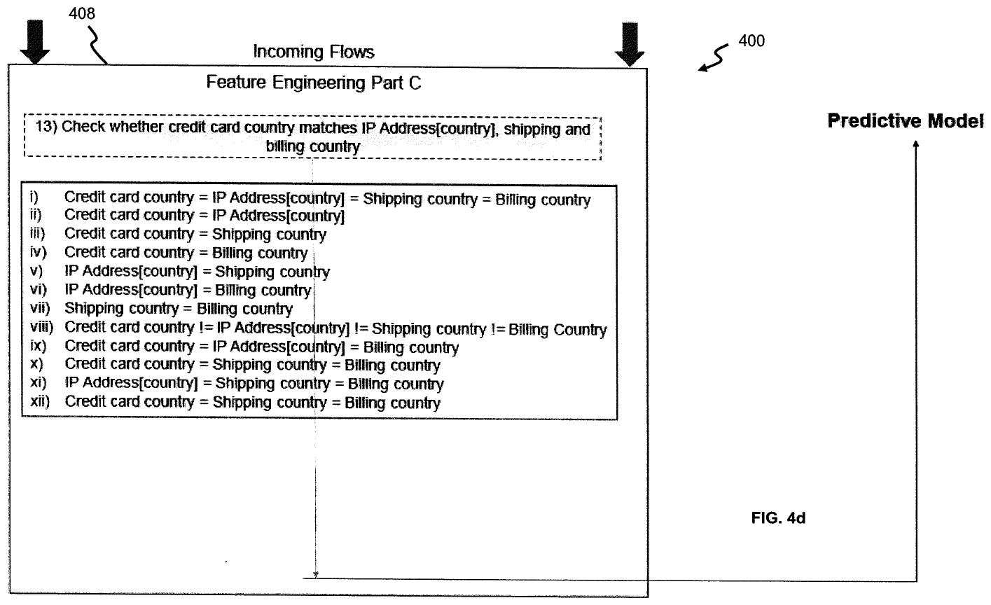

At step 312, the first and second validity scores are aggregated and normalized to provide a final validity score. If the final validity score is above a defined threshold value, then the transaction name is determined to be valid, and vice-versa. Thereafter, at step 314, the validity of an email address furnished by the payer for the digital transaction (i.e. transaction email address) is checked using an email model 354, where valid email addresses are checked and gibberish and non-meaningful addresses (e.g. repetitive sequence(s) of characters that may indicate a fake email address) are eliminated. On top of this, a validation check verifies using a 3^{rd} party API service at further step 316 whether the transaction email address, as furnished, is indeed an email address that has been activated and “alive”. When the transaction email address is determined to be valid, anomaly detection using the predictive model (in conjunction with a predictive model database 355) is performed at next step 318—this is done by the predictive anomaly detection module 1042. Any anomalous transaction will be flagged by the predictive anomaly detection module 1042, and scored with a first anomaly score “a” for fraud detection. FIGS. 4a to 4d collectively show flow diagrams 402, 404, 406, 408 of a method 400 performed by the predictive anomaly detection module 1042, and are fairly self-explanatory without need for further description herein.

Furthermore, a credit card number provided by the payer, which typically consist a total of 16 numbers, will be analysed. It is to be appreciated that the first 8 digits of any credit card number provide pertinent information that allow identification of a card provider, bank, account information, or the like associated with said credit card number. This information is able to provide important clues in determining whether the credit card is indeed valid, which consequently allows determination of whether the digital transaction is fraudulent. Upon completing the predictive anomaly detection, semantic anomaly detection is performed at step 320 (to generate a second anomaly score “β”), with velocity detection performed at subsequent step 322 (to generate a third anomaly score “χ”), and aggregate scoring performed at step 324 (to aggregate and normalise “α”, “β”, and “χ” to generate the aggregated score). It is to be appreciated that the steps 320, 322, 324 can be executed in sequence or in parallel, depending on configuration of the apparatus 100.

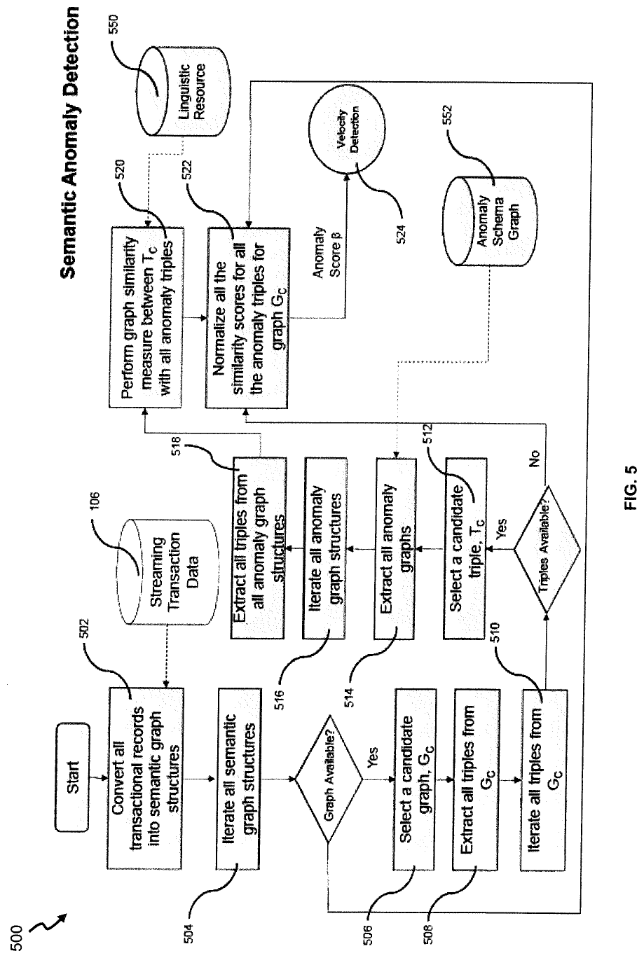

To also explain how the anomaly score is generated, it is mentioned above that the respective anomaly scores “α”, “β”, and “χ” output at steps 318, 320, 322 (by the predictive anomaly detection module 1042, semantic anomaly detection module 1044, and velocity detection module 1046 respectively) are aggregated and normalized. Each step 318, 320, 322 to be performed is associated with a weightage value. For example, for step 320 (i.e. semantic anomaly detection), the weightage value depends on which of the anomaly schema that can be projected on (i.e. semantically matched) and the user may also specify certain anomaly schemas to be weighted more than the rest, thus implying that this graph pattern is more anomalous/suspicious. It is disclosed that the weightage value used for step 320 is derived collectively from each of the anomaly schema that are stored in an anomaly schema graph database 552 (see FIG. 5). Then, the first anomaly score “α” from step 318 (i.e. predictive anomaly detection) is also associated with a weightage value, being a weightage value (associated with a rule triggered from the fraud rules repository 118), or a single combined weightage value resulting from a sum of weightage values (associated with a plurality of rules triggered from the fraud rules repository 118). The afore-described factors for steps 318, 320, 322 are fitted into a normalizer using the maximum entropy approach, so that a balanced and distributed anomaly score can be generated.

FIG. 5 shows a flow diagram 500 of steps performed by the semantic anomaly detection module 1044 in processing the received information data of the digital transaction, which expands in detail on step 320 of FIG. 3. It is to be appreciated that any received information data of digital transactions are stored in the form of tables, or in any form of a data repository. At step 502, a graph converter retrieves all transactional records from the streaming transaction database 106 for conversion into semantic graph structures, e.g. in this case, the received information data of the said digital transaction is retrieved and converted. A semantic graph structure comprises both concept and relation nodes. Each relation node {R₁, R₂ . . . Rₙ} in the anomaly graph patterns from a transaction graph schema 356 are weighted differently, as specified by a user. Then, all semantic graph structures are iterated at step 504, and a candidate graph, “G_{C}”, is selected at step 506. Then all triples are extracted from the candidate graph “G_{C}” at step 508, and the extracted triples from the candidate graph, “G_{C}”, are then iterated at step 510. Subsequently at step 512, a candidate triple, “T_{C}”, is selected, and followed by extracting all anomaly graph structures from the anomaly schema graph database 552 at step 514. All extracted anomaly graph structures are iterated at step 516, and triples are extracted from all the anomaly graph structures at step 518. A graph similarity measure is performed between the candidate triple, “T_{C}” with all anomaly triples at step 520, and all the similarity scores for all the anomaly triples for the candidate graph, “G_{C}” are normalized to generate the second anomaly score “β” at step 522. With that, it processes to velocity detection at step 524. It is to be appreciated that a triple (in the context of graph theory) essentially comprises two concept nodes attached to a relation node: in the form of [subject]-(relation)-[object]. Therefore, a semantic graph structure typically comprises several triples, which is why the sematic graph needs to be simplified where all possible triples are extracted from the graph.

For the graph similarity measurement in each of the triple, validation is performed to check if the concept conforms to the semantic constraint for each of the concepts. Once the concept is determined to conform to the semantic constraint, the concept is merged to the semantic structure to produce a new triple. The triple count is then incremented with a value of 1, and all the triple counts are consolidated. For example, assuming that the transaction graph contains 10 triples, and 5 of the triples fulfil the semantic constraints against the anomaly triples. The raw anomaly score for this transaction graph would be 0.5, but depending on which of the anomaly schema triple that can be projected on, certain anomaly patterns can be specified by the user to be weighted more than the rest, implying that this graph pattern will be more anomalous. Therefore, as a result, a total normalized score with the adjusted weights will produce the second anomaly score “β” at step 522, which then proceeds to the velocity detection at step 524.

To clarify what the semantic constraint means, a semantic constraint is like a boundary for matching a concept node. In a first example of an Anomaly Graph Schema for “Cards linked to multiple people”, this pattern identifies payment cards that have been linked to billing/shipping names that are substantially different from the card name provided for the associated transactions. To illustrate, a payment card in the name of “John Doe” has been used in transactions billing/shipping to different people with names such as “Jane Smith”, or “Lee Xiao Ming”. In a second example of an Anomaly Graph Schema for “People linked to multiple cards”, this pattern identifies people that have been linked to payment cards with substantially different names. This situation seems even more suspicious when the payment card name appears to be fake or dubious. To illustrate, the shipping name of “John Doe” has been used in transactions with multiple payment cards with names such as “gfdghdfh”, “aee fdsafew”. In a third example of an Anomaly Graph Schema for “Transactions linked to multiple countries”, this pattern identifies transactions that involve different countries, based on billing/shipping address, card issuer, transaction IP, and etc. To illustrate, a user with an internet session in Russia uses a card issued in Malaysia to ship to Singapore.

To summarise FIG. 5, at the initial stage, all the transactional records are converted into respective semantic graph structures and stored in the anomaly schema graph database 552. Subsequently, when a new transaction data is fetched, it is then converted into a semantic graph structure and added to the anomaly schema graph database 552. This does not affect the information data even if there is only one transaction in the streaming transaction database 106. This process is mainly concerned with transforming the transactional records into the semantic graph structures, and since all anomaly graph structures are already defined, it is only needed to compare the semantic graph structures against all the anomaly graph structures. All anomaly graph structures are fetched from the anomaly schema graph database 552 and iterated. At each iteration, each anomaly graph structure is simplified in terms of all the anomaly triples being extracted from this: {T1, T2, T3, . . . }. Subsequently all the triples extracted from the anomaly graph structures are iterated, and a candidate triple is projected upon all the triples extracted from the transactional record graph structure. A graph similarity measure is performed between all the triples to compute the second anomaly score “β”.

The concept nodes will refer to a linguistic resource database 550, being built from the Linked data repositories 352 (see FIG. 3). The linguistic resource database 550 is arranged to have all the concepts arranged in a hierarchical order and as well with all the instances attached to the related concepts. When comparing between the candidate triple and the anomaly triple, it is not merely an exercise in graph pattern matching. Rather, it involves using the semantic information from the linguistic resource database 550 to calculate the semantic distance of the concepts involved. For an example, when a transaction takes place in Abuja, and assuming if the anomaly schema defines that if any transaction from Nigeria will be suspicious, then from the linguistic resource database 550, it can be known that Abuja is a state in Nigeria. Therefore, when using the graph similarity coupled with the use of the linguistic resource database 550, semantic distance can be computed for each of the concept nodes. Coupled with a weighted relation node, this weightage influences an outcome of the score of the triple. Each candidate triple is scored and will be consolidated to be normalized with the total number of the triples per graph.

As an example to explain what the “concept node” and “instances” mean, if an anomaly graph structure is defined to denote if all transactional records that take place in Brazil is suspicious, then the schema is defined as follows:

### Anomaly Graph Structure #1:

[transaction]→(occur)→[region: “Central America”]

In this case, transaction and region are both concept nodes, whereas “Brazil” is specialized, therefore it is called an instance. That is, a semantic constraint for the relation to occur has been defined. The semantic constraints are transaction and region in this case.

The triple below will not match with “Anomaly Graph Structure #1” because the concept node violates the semantic constraint that was defined.

[transaction: “B6789”]→(occur)→[frequency: “3”]

Specifically, frequency and region are totally different concepts altogether, as will be appreciated.

It is to be appreciated that transaction, and country concepts are organized in the linguistic resource (i.e. acting like a dictionary but far beyond than just a simple list of terms, and it is different to taxonomy of words, as all the concepts are organized in a hierarchical order, where similar words in meaning are clustered in a same group. This is where the semantic distance will come to use).

Now, assuming a new transactional record is received by the apparatus 100 and is transformed by the graph converter into a graph structure:

From here (just an example to show how it works), Triple 1 is extracted from the whole graph structure.

### Triple 1:

[transaction: “A1234”]→(happen)→[location: “Guatemala”]

From Triple 1, it is known that there is a transaction occurring in Guatemala. When Triple 1 is projected upon the “Anomaly Graph Structure #1”, from the linguistic resource this matches, because location concept is subpart to region (as explained above, concepts are organized in hierarchical order, so from the linguistic resource this is easy to tell how the concepts relate to each other).

Hence, location and region produce a semantic concept similarity score between 0-1.

Similarly, it is the same with the relation nodes. Here the verbs “happen” and “occur” are semantically close in terms of ordinary English meaning, and from the linguistic resource, the score may be computed, as all the verbs are organized as well in the relational hierarchy. So, this produces a semantic similarity score between 0-1 as well.

From the linguistic resource, it can be computed that Guatemala is in Central America. Therefore, the score between the nodes [region: “Central America”] and [location: “Guatemala”] are semantically closely-related.

Summing up all the scores and normalizing with the total triples, it is then determinable as to whether the transactional record graph structure is anomalous.

Then, the workings of the velocity detection module 1046 (which comprises a velocity detection component and a temporal analysis component) are set out below as such:
1. Velocity Detection: The data from any digital transaction is checked against a Dynamic Group for criteria matching. If the criteria of the said digital transaction match the criteria for the Dynamic Group, a current temporary sum (“DGTemp”) for the Dynamic Group (“DGSum”) is incremented by a value, “DGIncr”. Thus, DGTemp=DGSum+DGIncr. This value, DGTemp, is compared to the maximal value defined for the group (DGMax). If DGTemp>=DGMax, then the third anomaly score “χ” is incremented. Thereafter, DGSum is then replaced by DGTemp. The respective definitions for some of the above terms are:
   Dynamic Group: A Group defined when a Dynamic Rule is created by the user. A Dynamic Group includes:
      Matching criteria to compare against incoming transactions. Matching criteria are any of the input data fields that the fraud detection module 104 is configured to accept. These criteria include a Time Period which is used by the Temporal Analysis component of the velocity detection module 1046.
      DGMax: A maximal value defined by a user of the apparatus 100. The maximal value can be either a count of events (which may be digital transactions or occurrence of data fields within the digital transaction) or a sum of some numeric data fields (e.g. a billing amount).
      DGSum: A current value for the sum that is to be compared with DGMax. DGSum itself is a sum of (DailySum1+DailySum2+ . . . ) values.
      DailySumn is a collection of values, where (n=Time Period). As an example, if Time Period=30 Days, then DailySumn is to be (DailySum1+DailySum2+ . . . +DailySum30) correspondingly.
   DGIncr: A numeric value derived from the transaction data fields (e.g. a billing amount) or a count of events (which may be transactions or occurrence of data fields within the digital transaction).
   DGTemp: A temporary value to hold the point-in-time sum of DGSum+DGIncr.
2. Temporal Analysis: The value for DGSum needs to take into account the Time Period defined as part of the matching criteria. If the Time Period is defined to be 30 days, for example, then DGSum is arranged to only hold values pertinent to transactional data from (Current Date−30 days). To allow for this, DGSum is to be re-evaluated at a regular interval to ensure that the compared sum is reasonably current.

In summary, the proposed apparatus 100 is advantageous in that a predictive model is utilised to perform detection of anomalies of digital transactions. Further, the apparatus 100 uses a semantic approach, where the transactional records are transformed into a set of semantic graphs, which are compared to the set of schema graphs in the knowledge base model, to perform detection of the anomalies. Moreover, the apparatus 100 provides the recommender module 116 to act upon the anomalies detected and improve the predictive model for a tighter fitting model to reduce false positives. The recommender module 116 is able to trigger which rules (i.e. simple, or, complex, or mixture of both), depending on a score of the anomaly detected.

While the invention has been illustrated and described in detail in the drawings and foregoing description, such illustration and description are to be considered illustrative or exemplary, and not restrictive; the invention is not limited to the disclosed embodiments. Other variations to the disclosed embodiments can be understood and effected by those skilled in the art in practising the claimed invention.

1. An apparatus for real-time detection of fraudulent digital transactions, comprising:
a transceiver module arranged to receive information data of a digital transaction;
a model generator module arranged to dynamically generate a predictive model for fraud detection based collectively on historical information data relating to identified fraudulent transactions and the received information data; and
a fraud detection module having a plurality of anomaly detection modules arranged to respectively process the received information data differently to generate a plurality of scores, which are aggregated to provide an aggregated score to enable real-time determination of whether the digital transaction is a fraudulent digital transaction,
wherein a first anomaly detection module is configured to process the received information data using the predictive model to generate a first score.

2. The apparatus of claim 1, wherein the fraud detection module further includes an aggregation module configured to aggregate the plurality of scores to provide the aggregated score.

3. The apparatus of claim 1, wherein the transceiver module includes being configured to transmit the aggregated score to a payment server from which the digital transaction originates.

4. The apparatus of claim 1, wherein the plurality of scores are arranged to be normalised, prior to being aggregated.

5. The apparatus of claim 1, wherein the model generator module includes being configured to use machine learning to dynamically generate the predictive model.

6. The apparatus of claim 1, wherein the model generator module includes:
a data transformation module to process the received information data into an associated data representation with reference to a predetermined format;
an extraction module to extract respective values of predetermined data fields in the data representation; and
a model building module to generate the predictive model based on the extracted values.

7. The apparatus of claim 1, wherein the fraud detection module is further configured to provide an anomaly score, further comprising:
a recommender module arranged to receive the anomaly score and compare the anomaly score with a threshold value to generate a signal,
wherein based on the generated signal, the recommender module is configured to trigger at least one rule from a fraud rules database, and a weightage value associated with the triggered rule is provided to at least the first anomaly detection module to enable the first anomaly detection module to use the weightage value to process information data of a new digital transaction received.

8. The apparatus of claim 7, wherein the at least one rule includes a plurality of rules, and respective weightage values are associated with respective rules, and wherein the weightage values are combined and normalized into a single weightage value which is provided to the first anomaly detection module.

9. The apparatus of claim 1, wherein a second anomaly detection module is configured to process the received information data using semantic anomaly detection or velocity detection with temporal analysis to generate a second score.

10. The apparatus of claim 1, wherein the aggregated score is compared against a predetermined threshold value, in which the aggregated score being greater than the threshold value indicates a fraudulent digital transaction, and the aggregated score being smaller than the threshold value indicates a non-fraudulent digital transaction.

11. The apparatus of claim 1, wherein the apparatus includes a computing device.

12. A method performed by an apparatus for real-time detection of fraudulent digital transactions, the apparatus includes a transceiver module, a model generator module, and a fraud detection module having a plurality of anomaly detection modules, the method comprises:
(i) receiving information data of a digital transaction by the transceiver module;
(ii) dynamically generating a predictive model for fraud detection by the model generator module based collectively on historical information data relating to identified fraudulent transactions and the received information data; and
(iii) respectively processing the received information data differently by the plurality of anomaly detection modules to generate a plurality of scores, which are aggregated to provide an aggregated score to enable real-time determination of whether the digital transaction is a fraudulent digital transaction,
wherein the received information data is processed by a first anomaly detection module using the predictive model to generate a first score.
